(19) United States
(12) Patent Application Publication
(10) Pub. No.: US 2011/0307148 A1
(43) Pub. Date: Dec. 15, 2011

(54) OCCUPANT DETECTION SYSTEM AND METHOD HAVING HEATER ELEMENT ELECTRICAL ISOLATION

(75) Inventors: Dennis P. Griffin, Noblesville, IN (US); Andrew H. Curtis, Kokomo, IN (US)

(73) Assignee: DELPHI TECHNOLOGIES, INC., Troy, MI (US)

(21) Appl. No.: 12/797,658

(22) Filed: Jun. 10, 2010

(51) Int. Cl. G06F 7/00; H02B 1/24; B60R 21/015

(52) U.S. Cl. 701/45; 701/36; 307/112; 307/116

(57) ABSTRACT

A system for determining an occupant proximate to a vehicle seat, a controller for use in the system, and a method for electrically isolating a heater element from an occupant detection electrode. When a heater element in a seat is coupled to a heater voltage source to generate heat, the heater element may influence an electric field generated by an occupant detection electrode in such a way as to interfere with determining an occupant proximate to the seat. Depending on the arrangement of the electrode and the heater element, such interference may be present at all times when the electrode is connected to the heater voltage source, or may only be problematic when the seat is wet with liquid moisture. By electrically isolating the heater element, the influence on the electric field may be reduced so the process of determining if an occupant is present in the seat is not interfered with.

### TECHNICAL FIELD OF INVENTION

The invention generally relates to vehicle passenger occupant detection, and more particularly relates to a system and method to electrically isolate a seat heater element so the heater element does not interfere with the determining of an occupant.

### BACKGROUND OF INVENTION

It is known to selectively enable or disable a vehicle air bag or other occupant protection device based on the presence of an occupant in a seat. It has been proposed to place electrically conductive material in a vehicle seat to serve as an occupant detection electrode for detecting the presence of an occupant in the seat. For example, U.S. Patent Application Publication No. 2009/0267622 A1, which is hereby incorporated herein by reference, describes a vehicle occupant detector that determines the presence of an occupant by applying an excitation signal to the occupant detection electrode and analyzing how the occupant influences the excitation signal. The occupant affects the electrical field radiated by the occupant detection electrode in response to the excitation signal, and thereby influences the excitation signal. Humidity and liquid moisture also influence the excitation signal and so may affect the accuracy of determining an occupant.

### SUMMARY OF THE INVENTION

In accordance with one embodiment of this invention, a system for determining an occupant proximate to a vehicle seat is provided. The system includes an occupant detection electrode, a heater element, and an electrical isolation means. The occupant detection electrode is configured to influence an excitation signal in accordance with an occupant presence proximate to the vehicle seat for determining the occupant. The heater element is configured to generate heat in response to a heater voltage for warming the occupant. The electrical isolation means selectively electrically isolates the heater element such that the heater element does not interfere with a determination of the occupant.

In another embodiment of the present invention, a controller for determining an occupant proximate to a vehicle seat is provided. The controller includes an excitation signal output, a heater voltage output, and an electrical isolation means. The excitation signal output is configured to allow an excitation signal applied to an occupant detection electrode to be influenced in accordance with an occupant presence proximate to the vehicle seat for determining the occupant. The heater voltage output is configured to supply a heater voltage to a heater element to generate heat in response to the heater voltage for warming the occupant. The electrical isolation means is configured to selectively electrically isolate the heater element such that the heater element does not interfere with determining the occupant.

In yet another embodiment of the present invention, a method for electrically isolating a heater element from an occupant detection electrode is provided. The method includes the steps of coupling a first contact of a heater element to a first voltage output of a heater voltage source with a first electrically isolating switch and coupling a second contact of a heater element to a second voltage output of a heater voltage source with a second electrically isolating switch. The method also includes the step of operating the first electrically isolating switch to a first switch open state and the second electrically isolating switch to a second switch open state to electrically isolate the heater element such that the heater element does not interfere with a determination of an occupant.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic diagram of an occupant detection system in accordance with one embodiment; and

FIG. 2 is flowchart of a method for electrically isolating a heater element from an occupant detection electrode of FIG. 1, in accordance with one embodiment.

### DETAILED DESCRIPTION OF INVENTION

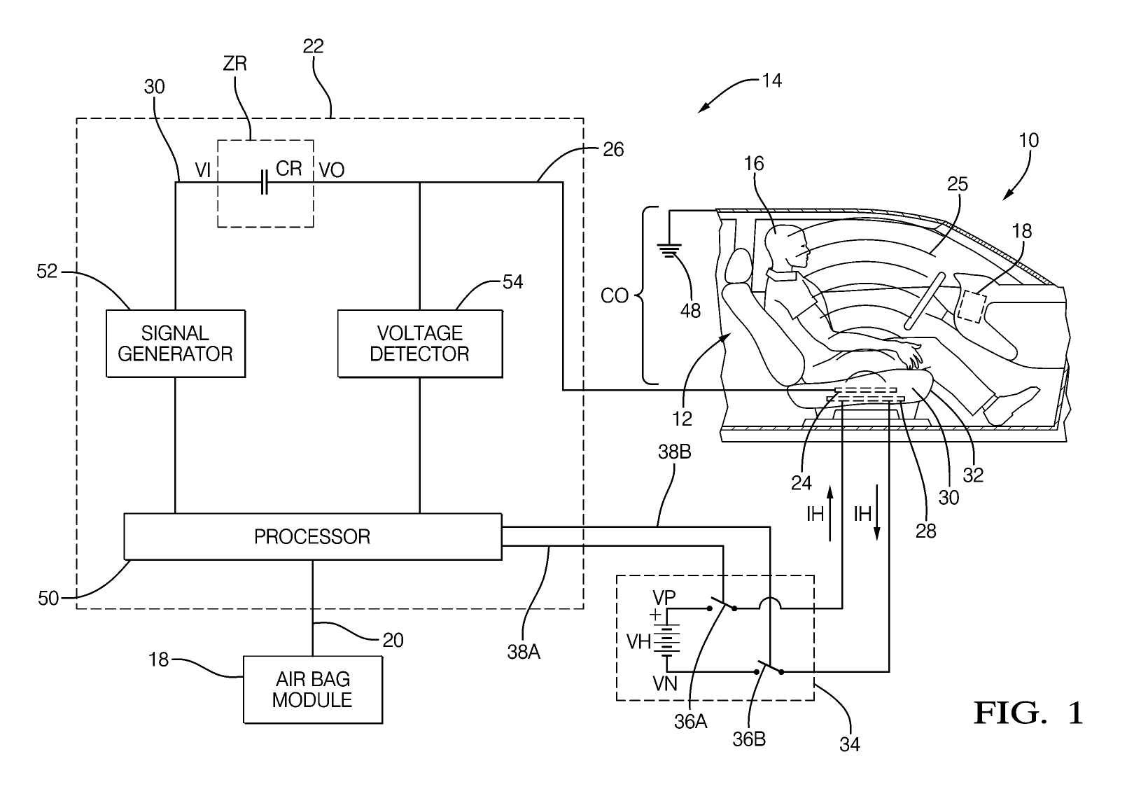

In accordance with an embodiment of a system for determining an occupant proximate to a vehicle seat, FIG. 1 illustrates a non-limiting embodiment a vehicle 10 that includes a vehicle seat 12 and an occupant detection system 14 for determining an occupant 16 residing on or proximate to the vehicle seat 12. As used herein, characterizing an occupant or object being proximate to a seat means that the occupant may be residing upon the seat in a number of orientations including, but not limited to, sitting facing forward and leaning back against a backrest, sitting facing forward and leaning forward away from the back rest, sitting facing sideways, sitting on the edge of the seat, sitting in an infant car seat that is secured to the seat with a seat belt or other means. Furthermore, as used herein, ‘determining an occupant proximate to a vehicle seat’ or ‘determining an occupant’ means not only detecting a presence of an occupant, but may also include making a determination about a characteristic of the occupant such as, but not limited to, size, weight, or if the occupant is residing in an infant seat or a child booster seat. It will be appreciate that the occupant detection system 14 may be used in any kind of vehicle, such as an airplane, construction equipment, or an automobile. As used herein, determining the occupant 16 may include detecting the presence of an occupant such as an adult as illustrated which may be useful when checking to determine if the seat belt should be fastened, or activating a warning if the seat belt is not properly deployed. Determining an occupant may also include characterizing the occupant (e.g., adult versus infant) which may be useful for enabling or disabling the air bag module 18 or other passenger protection devices in the vehicle. It is advantageous to disable the air bag module 18 if the vehicle seat is empty or occupied by an infant in a child seat so the air bag is not unnecessarily deployed. The air bag module 18 may receive an activation signal 20 from a controller 22 to arm the air bag module 18 so that a signal from a collision detection system (not shown) can deploy the air bag when necessary. The controller 22 may include a processor such as a microprocessor or other control circuitry as should be evident to those in the art. The controller 22 may include memory, including non-volatile memory, such as electrically erasable programmable read-only memory (EEPROM) for storing one or more routines, thresholds and captured data. The one or more routines may be executed by the processor to perform steps for determining if signals received by the controller 22 for determining an occupant as described herein.

FIG. 1 illustrates an exemplary, non-limiting embodiment of the system 14 that includes of an occupant detection electrode 24 electrically coupled to the controller 22. The electrode 24 may be arranged proximate to or adjacent to an expected location of the occupant 16 for determining the occupant 16. The electrode 24 may be formed of a variety of electrically conductive materials such as metal wire, conductive fiber, conductive ink, metal foil, or metal ribbon. The controller 22 may be configured to output an excitation signal 26 to the occupant detection electrode 24 to generate an electric field 25 that impinges on the occupant 16. In one non-limiting example, the excitation signal 28 may arise from an input signal VI passing through a reference voltage ZR to generate an output signal VO that is output by the controller 22 as the excitation signal 28. While not subscribing to any particularly theory, it has been observed that the presence of the occupant 16 influences characteristics the excitation signal 26, such as amplitude and phase, in accordance with various aspects of the occupant 16, such as the presence of the occupant proximate to the vehicle seat 12, or the size of the occupant occupying the vehicle seat 12. As such, the occupant detection electrode 24 may be particularly configured so the occupant 16 readily influences the excitation signal 26 in accordance with an occupant presence proximate to the vehicle seat 12 for determining the occupant 16. It has also been observed that by positioning the occupant detection electrode 24 closer to the seating surface occupied by the occupant 16, the accuracy, and sensitivity of the occupant detection system 14 for determining and occupant 16 is improved.

The system may also include a heater element 28 configured to generate heat in response to a heater voltage source VH for warming the occupant 16. The heater element 28 may be formed of electrically conductive material that exhibits an electrical resistance so that when the heater voltage source VH is applied to the heater element 28, a heater current IH is generated that flows through the heater element 20 to generate heat. The heater voltage source VH is illustrated in FIG. 1 as a separate battery, but it is understood that the heater voltage source VH would typically be provided by the vehicle electrical system that normally includes a battery such as a rechargeable lead-acid battery commonly found in automobiles. In an operating automobile, a typical voltage value for the heater voltage is about 12 Volts to about 15 Volts, and a suitable resistance value for the heater element 28 is about 3 Ohms. It will be appreciated that locating the heater element 28 closer the seating surface occupied by the occupant 16 will improve the thermal efficiency of the heater element 28 for warming the occupant 16.

A typical vehicle seat 12 may include a cushion 30 that typically is formed of foam and shaped to be comfortable to sit upon. The cushion 30 may be covered with a seat cover 32 that may be formed of fabric or leather to make the vehicle seat 12 attractive. As suggested above, it may be preferably for the occupant detection electrode 24 and the heater element 28 to both be located as close to the occupant 16 as possible. For example, the occupant detection electrode 24 and the heater element 28 may be positioned between the cushion 30 and the seat cover 32. In one embodiment the occupant detection electrode 24 is arranged within the vehicle seat 12 proximate to a seating surface, and the heater element 28 is arranged proximate to the occupant detection electrode 26 opposite the seating surface; that is below the electrode 26. For this embodiment, and other embodiments having the occupant detection electrode 24 and the heater element 28 in close proximity to each other, it has been observed that the presence or absence of the heater element 28 may affect or interfere with the accuracy of determining the occupant 16. It has also been observed that when liquid moisture is introduced into such a vehicle seat 12, for example by a spilled beverage, a wet bathing suit, or from rain entering an open vehicle window; the occupant detection system 14 may further interfere with the accuracy of determining the occupant 16. Furthermore, it has been observed that the degree of interference that the heater element 28 has on determining the occupant 16 may correspond to the amount of moisture, liquid or vapor, present in or on the cushion 30. Testing has indicated that an electrically resistive leakage path between the electrode 24 and the heater element 28 may occur when liquid water is pour onto the cushion 30. For a controller 22 having a voltage detector 54 that determines an amplitude of the excitation signal 26, the resistive portion of an impedance exhibited by the electrode 24 may cause the amplitude detected by the voltage detector 54 to decrease and then, for example, the controller 22 may indicate the presence of an occupant when none is actually present, or indicate that the occupant is larger than actual.

Testing has demonstrated that if the heater element 28 is electrically isolated from the system 14, the accuracy of determining the occupant 16 is improved. As used herein, the use of the term ‘electrically isolate’ means to electrically disconnect or electrically decouple an object such as the heater element 28 so there is no substantial electrical communication with the object. Electrical communication is generally characterized as being through a conductive path or through capacitive coupling. Use of the term ‘electrically isolate’ with regard to the heater element 28 means that the heater element 28 is electrically disconnected or electrically decoupled from any signal source such that the heater element 28 is electrically floating and not biased to any particular voltage potential. By electrically isolating the heater element 28 it is believed that influence on the electric field 25 radiated by the occupant detection electrode 24 is minimized. As such, when the excitation signal 26 present on the occupant detection electrode 24 is analyzed, the heater element 28 does not substantially influenced the excitation signal 26 and so does not interfere with determining the occupant 16. According to this definition, a heater element 28 connected to a signal source that provides a guarding signal to match the voltage of a heater element to the voltage of an occupant detection electrode, such as described in EP2085263 by Petereit et al., is not electrically isolated and so is specifically excluded by this definition. It follows that it may be advantageous for the system 14 to include an electrical isolation means 34 configured to selectively electrically isolate the heater element 28 such that the heater element 28 does not interfere with a determination of the occupant 16.

FIG. 1 shows a non-limiting example of an electrical isolation means 34 that includes electrically isolating switches that electrically isolate the heater element 28 from the heater voltage source VH when opened. Since opening the switches may stop the heater element 28 from generating heat, it may be advantageous for the system 14 to be configured so the electrical isolation means 34 electrically isolates the heater element 28 only when the excitation signal 26 is present. When the excitation signal is not present, the system 14 is generally not determining the occupant 16, and so the heater element may be connected to the heater voltage source VH.

It has been observed that environmental conditions such as temperature, relative humidity, or the presence of liquid moisture may affect the process of determining the occupant 16. As such, it may be advantageous for the system 14 to include an environmental detection means configured to detect an environmental condition. Based on the environmental condition detected, the system 14 may be configured so the electrical isolation means electrically isolates the heater element when the environmental condition is indicated. The environmental detection means may be by way of a discrete sensor, such as a temperature sensor (not shown) or a separate humidity sensor (not shown).

It has been suggested that the excitation signal may be analyzed to determine relative humidity and/or liquid moisture in the vehicle seat 12, see U.S. patent application Ser. No. 12/700,243 filed Feb. 4, 2010, the entire contents of which is hereby incorporated herein by reference. It follows that the environmental condition indicated may be based on the excitation signal 26. It also follows that the environmental condition indicated may include an indication of a presence of moisture proximate to the occupant detection electrode 24. As used herein, the presence of moisture proximate to the electrode includes, but is not limited to conditions where moisture is present either within or on top of the seat cushion 30, either in the form of vapor or liquid, and so may or may not be indirect contact with the electrode 24. The system 14 may be configured to selectively electrically isolate the heater element 28 either only when an environmental condition such as a wet seat is detected, or only when the excitation signal 26 is present, or only when both the environmental condition is detected and the excitation signal 26 is present. The conditions selected for when the heater element is to be isolated may be determined based on empirical testing, or may be selected based on other design features of the electrical isolation means 34.

In one embodiment of the system 14, the heater element may be formed of a length of electrically conductive material as suggested above. The length of electrically conductive material may include a first contact at a first end of the length of electrically conductive material, and a second contact at a second end of the length of electrically conductive material opposite the first end. For example, the heater element 28 may be a length of wire with the first and second contacts located at opposite ends of the wire. Alternately, the heater element may be in the form of a sheet or ribbon of conductive material with the first and second contacts generally located at opposite sides of the sheet or ribbon so that current passing through the heater element 28 is effective to generate heat over a area of the sheet or ribbon. The system 14 may further comprise a heater voltage source VH source having a first voltage output VP and a second voltage output VN. The heater voltage source VH is shown separate from the controller 22; however it will be appreciated that the heater voltage source VH could be incorporated within the controller 22. When the heater voltage source VH is electrically connected to the heater element 28, the first voltage output VP and the second voltage output VN cooperate to supply a heater current to warm the heater element. For example, the first voltage output VP may have a first voltage value that is greater than a second voltage value of the second voltage output VN such that a heater current IH is supplied to the heater element 28 as illustrated in FIG. 1.

The electrical isolation means 34 may include a first electrically isolating switch 36A coupling the first contact of the heater element 28 to the first voltage output VP. The first electrically isolating switch 36A may be operable to a first switch closed state that electrically connects the first contact to the first voltage output VP, and a first switch open state that electrically isolates the first contact from the first voltage output VP. The electrical isolation means 34 may also include a second electrically isolating switch 36B coupling the second contact of the heater element 28 to the second voltage output VN. The second electrically isolating switch 36B may be operable to a second switch closed state that electrically connects the second contact to the second voltage output VN, and a second switch open state that electrically isolates the second contact from the second voltage output VN. As such, the switches 36A and 36B may be operated to selectively electrically isolate the heater element, such as when necessary during certain selected conditions.

The first switch 36A and the second switch 36B may receive independent first and second control signals 38A, 38B from the controller 22. With this arrangement, the switches 36A and 36B may be operated independently or simultaneously by the controller 22. In one instance, operating the first electrically isolating switch 36A to the first switch closed state and the second electrically isolating switch 36B to the second switch closed state electrically connects the heater voltage source VH to the heater element 28 so the heater current IH flows from the heater voltage source VH to the heater element 28. In another instance, operating the first electrically isolating switch 36A to the first switch open state and the second electrically isolating switch 36B to the second switch open state electrically isolates the heater element 28.

A non-limiting example of the electrical isolation means 34 has a first electrically isolating switch 36A that includes a first relay and the second electrically isolating switch 36B includes a second relay. In one embodiment, the switches 36A and 36B may consist of only a first and second relay respectively, such as electromechanical relays having mechanical contacts. Typical electromechanical relays suitable for switching the voltages and currents present in the heater element 28 will exhibit virtually no conductivity, for example open state resistances greater than 10 Mega-Ohms (10E6 Ohms), and very low capacitive coupling, for example less than 5 pF. In another embodiment, each electrically isolating switch 36A and 36B may include both a relay for electrical isolation switch, and solid state devices such as MOSFETs for pulse width modulating power from the heater voltage source VH to the heater element 28 to regulate the average power dissipated by the heater element 28. In another embodiment, the electrically isolating switches 36A and 36B may be formed of only solid state devices such as shown in U.S. patent application Ser. No. 12/443,923 filed May 1, 2009, the entire contents of which is hereby incorporated herein by reference.

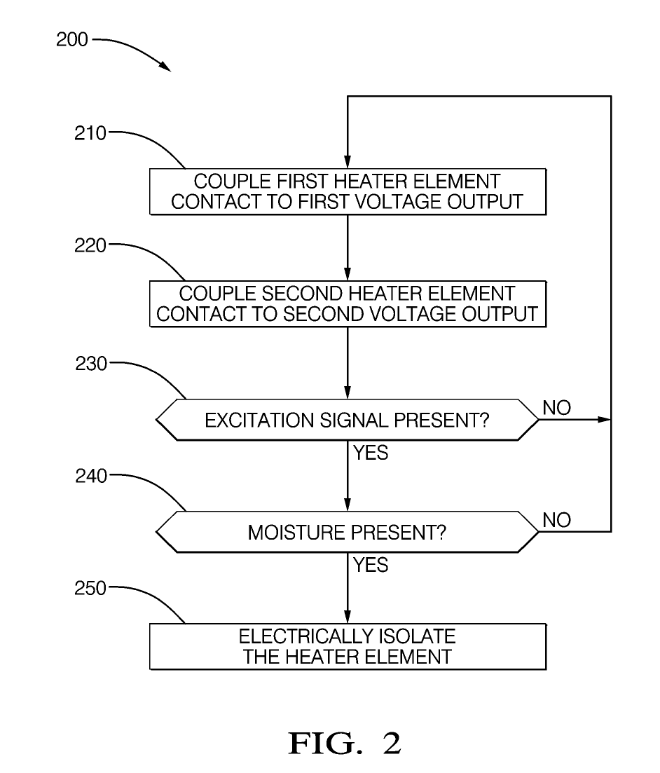

FIG. 2 illustrates a method 200 for electrically isolating a heater element 28 from an occupant detection electrode 24. At step 210, the first contact to the heater element 28 may be coupled to the first voltage output VP of a heater voltage source VH with a first electrically isolating switch 36A. At step 220, the second contact to the heater element 28 may be coupled to the second voltage output VN of a heater voltage source VH with a second electrically isolating switch 36B. When the heater element 28 is coupled to the hater voltage source VH, the heater element 28 may generate heat to warm the occupant 16.

At step 230, it may be determined if the excitation signal 26 is present on the occupant detection electrode 28. If the excitation signal 26 is not present, then the routine may return to step 210 and so the heater element 28 remains electrically coupled to the heater voltage source VH. If an excitation signal 26 is present on the occupant detection electrode 24, then the method 200 may proceed to step 240. Alternately, it may be desirable to electrically isolate the heater element 28 anytime the excitation signal 26 is present, and so the method 200 may bypass step 240 and proceed directly to step 250 where the heater element 28 is eclectically isolated by the electrical isolation means 34.

At step 240, it may be determined if moisture, either vapor or liquid, is present proximate to the heater element 28. If no moisture is detected, it may be unnecessary to electrically isolate the heater element 28 for some configurations of the seat 12, and so the method 200 may return to step 210. However, for some configurations of the seat 12, the presence of moisture or liquid proximate to the occupant detection electrode 24, it may be advantageous to electrically isolate the heater element 28 such that the heater element 28 does not interfere with a determination of an occupant 16. An alternate embodiment of the method 200 may omit step 230 such that the only criteria used for deciding to electrically isolate the heater element 28 is the presence of moisture. The inclusion of steps 230 and 240 as illustrated provides a method 200 that electrically isolates the heater element when both the environmental condition is determined and an excitation signal 26 is present on occupant detection electrode 24.

Accordingly, a system 14 for determining an occupant proximate to a vehicle seat, a controller 22 for use in the system 14, and a method 200 for electrically isolating a heater element from an occupant detection electrode is provided. When a heater element 28 in a seat 12 is coupled to a heater voltage source VH to generate heat, the heater element 28 may influence an electric field 25 generated by an occupant detection electrode 24 in such a way as to interfere with determining an occupant 16 proximate to the seat. Depending on the arrangement of the electrode 24 and the heater element 28, such interference may be present at all times when the electrode 24 is connected to the heater voltage source VH, or may only be problematic when the seat 12 is wet with liquid moisture. By electrically isolating the heater element 28, the influence on the electric field 25 may be reduced so the process of determining if an occupant 16 is present in the seat 12 is not interfered with.

While this invention has been described in terms of the preferred embodiments thereof, it is not intended to be so limited, but rather only to the extent set forth in the claims that follow.

We claim:

1. A system for determining an occupant proximate to a vehicle seat comprising:
an occupant detection electrode configured to influence an excitation signal in accordance with an occupant presence proximate to the vehicle seat for determining the occupant;
a heater element configured to generate heat in response to a heater voltage for warming the occupant; and
an electrical isolation means that selectively electrically isolates the heater element such that the heater element does not interfere with a determination of the occupant.

2. The system in accordance with claim 1, wherein the electrical isolation means electrically isolates the heater element when the excitation signal is present.

3. The system in accordance with claim 1, wherein the system further comprises an environmental detection means for detecting an environmental condition, wherein the electrical isolation means electrically isolates the heater element when the environmental condition is indicated.

4. The system in accordance with claim 3, wherein the environmental condition indicated is based on the excitation signal.

5. The system in accordance with claim 3, wherein the environmental condition indicated comprises a presence of moisture proximate to the occupant detection electrode.

6. The system in accordance with claim 1, wherein the system further comprises an environmental detection means for detecting an environmental condition, and the electrical isolation means electrically isolates the heater element when the environmental condition is indicated and the excitation signal is present.

7. The system in accordance with claim 1, wherein the heater element is formed of a length of electrically conductive material having a first contact at a first end of the length of electrically conductive material and a second contact at a second end of the length of electrically conductive material opposite the first end, said system further comprising a heater voltage source having a first voltage output and a second voltage output, wherein when the voltage source is electrically connected to the heater element, the first voltage output and the second voltage output cooperate to supply a heater current to warm the heater element.

8. The system in accordance with claim 7, wherein the electrical isolation means comprises
a first electrically isolating switch coupling the first contact to the first voltage output, said first electrically isolating switch operable to a first switch closed state that electrically connects the first contact to the first voltage output, and a first switch open state that electrically isolates the first contact from the first voltage output; and
a second electrically isolating switch coupling the second contact to the second voltage output, said second electrically isolating switch operable to a second switch closed state that electrically connects the second contact to the second voltage output, and a second switch open state that electrically isolates the second contact from the second voltage output,
wherein operating the first electrically isolating switch to the first switch closed state and the second electrically isolating switch to the second switch closed state electrically connects the heater voltage source to the heater element so the heater current flows from the heater voltage source to the heater element.

9. The system in accordance with claim 8, wherein operating the first electrically isolating switch to the first switch open state and the second electrically isolating switch to the second switch open state electrically isolates the heater element.

10. The system in accordance with claim 9, wherein the first electrically isolating switch comprises a first relay and the second electrically isolating switch comprises a second relay.

11. The system in accordance with claim 1, wherein the occupant detection electrode is arranged within the vehicle seat proximate to a seating surface, and the heater element is arranged proximate to the occupant detection electrode opposite the seating surface.

12. The system in accordance with claim 1, wherein the system further comprises an air bag module receiving an activation signal based the determination of the occupant.

13. A controller for determining an occupant proximate to a vehicle seat comprising:
an excitation signal output configured to allow an excitation signal applied to an occupant detection electrode to be influenced in accordance with an occupant presence proximate to the vehicle seat for determining the occupant;
a heater voltage output configured to supply a heater voltage to a heater element to generate heat in response to the heater voltage for warming the occupant; and
an electrical isolation means configured to selectively electrically isolate the heater element such that the heater element does not interfere with determining the occupant.

14. The controller in accordance with claim 13, wherein the controller is further configured to determine an environmental condition based on the excitation signal, wherein the controller electrically isolates the heater element when the environmental condition is indicated.

15. A method for electrically isolating a heater element from an occupant detection electrode comprising the steps of:
coupling a first contact of a heater element to a first voltage output of a heater voltage source with a first electrically isolating switch;
coupling a second contact of a heater element to a second voltage output of a heater voltage source with a second electrically isolating switch; and
operating the first electrically isolating switch to a first switch open state and the second electrically isolating switch to a second switch open state to electrically isolate the heater element such that the heater element does not interfere with a determination of an occupant.

16. The method in accordance with claim 15, wherein the step of operating the first electrically isolating switch and the second electrically isolating switch to isolate the heater element occurs when an excitation signal is present on occupant detection electrode.

17. The method in accordance with claim 15, wherein the method further comprises the step of determining an environmental condition, and the step of operating the first electrically isolating switch and the second electrically isolating switch to isolate the heater element occurs when the environmental condition is determined.

18. The method in accordance with claim 17, wherein the step of determining an environmental condition is based on the excitation signal.

19. The method in accordance with claim 17, wherein the step of determining an environmental condition includes determining a presence of moisture proximate to the occupant detection electrode.

20. The method in accordance with claim 15, wherein the method further comprises the step of determining an environmental condition, and the step of operating the first electrically isolating switch and the second electrically isolating switch to isolate the heater element occurs when the environmental condition is determined and an excitation signal is present on occupant detection electrode.
